(19) United States
(12) Patent Application Publication
(10) Pub. No.: US 2023/0131570 A1
(43) Pub. Date: Apr. 27, 2023

(54) Method, apparatus and processing device for determining mechanical performance of a road

(71) Applicant: INSTITUTE OF ROCK AND SOIL MECHANICS, CHINESE ACADEMY OF SCIENCES, Wuhan City (CN)

(72) Inventors: Zheng LU, Wuhan City (CN); Yang ZHAO, Wuhan City (CN); Hailin YAO, Wuhan City (CN); Chuxuan TANG, Wuhan City (CN); Jie LIU, Wuhan City (CN)

(73) Assignee: INSTITUTE OF ROCK AND SOIL MECHANICS, CHINESE ACADEMY OF SCIENCES, Wuhan City (CN)

(21) Appl. No.: 17/809,001

(22) Filed: Jun. 26, 2022

(30) Foreign Application Priority Data
Oct. 22, 2021 (CN) 202111235086.2

(51) Int. Cl. G06F 30/13

(52) U.S. Cl. CPC G06F 30/13; G06F 2111/10

(57) ABSTRACT

A method for determining mechanical performance of the road includes the following: acquiring an initial subgrade reaction modulus kₛ of a subgrade of a target road section by using a field plate-bearing test process; acquiring a preset load p of the subgrade and geocell parameters of a preset geocell of the subgrade; calculating a composite subgrade reaction modulus kᵣ of the subgrade on condition that the roadbed is under a reinforced working condition by a composite modulus calculation formula; calculating an equivalent thickness RP of the roadbed under the reinforced working condition by a depth adjustment calculation formula; and outputting the composite subgrade reaction modulus kᵣ and the equivalent thickness RP.

### CROSS-REFERENCE TO RELATED APPLICATION

The present application claims priority to Chinese Patent Application No. 202111235086.2 filed on Oct. 22, 2021, the disclosure of which is hereby incorporated by reference in its entirety.

### BACKGROUND

Road can be divided into two parts of an upper roadbed and a lower subgrade in structure. The subgrade is the base of an entire road and bears the transportation load above the road; at the same time, it is affected by environmental factors such as climate. During the service period, the subgrade must have sufficient strength, rigidity and stability. The roadbed is located on the top of the entire subgrade and bears the main load and disperses loading capacity. In this context, it is of great significance to ensure that the roadbed has good performance in order to provide road usability and extend service period.

### SUMMARY

The present disclosure relates to the geological field, in particular to a method, an apparatus and a processing device for determining mechanical performance of a road.

The present disclosure provides a method, an apparatus and a processing device for determining mechanical performance of a road, which can provide accurate and effective data support for facilitating the progress of geocell reinforcement work in the case of introducing geocell to reinforce roadbed.

In a first aspect of the present disclosure, a method for determining mechanical performance of a road is provided. The method may include:

acquiring, by a processing device, an initial subgrade reaction modulus kₛ of a subgrade of a target road section by using a field plate-bearing test process, wherein the target road section is a section of which the mechanical performance is to be evaluated, the initial subgrade reaction modulus is used to indicate a ratio of a vertical pressure to a deflection s at a target point on a top surface of the subgrade, the initial subgrade reaction modulus is determined on condition that a roadbed of the target road section is under an un-reinforced working condition, and the target road section comprises the roadbed and the subgrade from surface to interior in turn;

acquiring, by the processing device, a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;

calculating, by the processing device, a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:

$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$

wherein, A, B, C, E, F, G, I, J are respectively preset constants, Pa is standard atmospheric pressure, D is a diameter of a bearing plate in the field plate-bearing test process;

calculating, by the processing device, an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:

$$R P = L \times {( \frac{u}{D} )}^{4} + M \times {( \frac{u}{D} )}^{3} + N \times {( \frac{u}{D} )}^{2} + Q \times \frac{u}{D} + T$$

wherein, L, M, N, Q, and T are respectively preset constants; and

outputting, by the processing device, the composite subgrade reaction modulus kᵣ and the equivalent thickness RP, so as to provide data support for an engineering processing of the target road section.

In connection with the first aspect of the preset disclosure, in a first possible implementing way of the first aspect, A=−2.994, B=−0.465, C=0.553, E=0.334, F=3.201, G=0.0945, I=0.314, J=0.891.

In connection with the first aspect of the preset disclosure, in a second possible implementing way of the first aspect of the preset disclosure, L=−1.328, M=2.857, N=−1.762, Q=0.18, T=0.678.

In connection with the first aspect of the preset disclosure, in a third possible implementing way of the first aspect of the preset disclosure, the acquiring, by the processing device, the initial subgrade reaction modulus kₛ of the subgrade of the target road section using the field plate-bearing test process includes:

acquiring, by the processing device, a first subgrade reaction modulus kₛ₁ of the subgrade by the field plate-bearing test process;

acquiring, by the processing device, a data of a load displacement ps curve of a soil body of the subgrade under the un-reinforced working condition; and

calculating, by the processing device, an inverted second subgrade reaction modulus kₛ₂ by taking the first subgrade reaction modulus kₛ₁, the data of the load displacement ps curve, the preset load p of the subgrade and the geocell parameters of the preset geocell of the subgrade as third input parameters and performing an inversion process, and taking, by the processing device, the inverted second subgrade reaction modulus kₛ₂ as the initial subgrade reaction modulus kₛ.

In connection with the first aspect of the preset disclosure, in a fourth possible implementing way of the first aspect of the preset disclosure, the acquiring, by the processing device, the initial subgrade reaction modulus kₛ of the subgrade of the target road section using the field plate-bearing test process includes after detecting a geocell reinforcement treatment event, acquiring, by the processing device, the initial subgrade reaction modulus kₛ through the field plate-bearing test process.

In connection with the first aspect of the preset disclosure, in a fifth possible implementing way of the first aspect of the preset disclosure, the outputting, by the processing device, the composite subgrade reaction modulus kᵣ and the equivalent thickness RP includes:

generating, by the processing device, a road section data report of the target road section based on the composite subgrade reaction modulus kᵣ and the equivalent thickness RP, wherein the road section data report is marked with the composite subgrade reaction modulus kᵣ and the equivalent thickness RP; and

outputting, by the processing device, the road section data report.

In a second aspect of the present disclosure, an apparatus for determining mechanical performance of a road is provided. The apparatus may include:

an acquisition unit configured to acquire an initial subgrade reaction modulus kₛ of a subgrade of a target road section by using a field plate-bearing test process, wherein the target road section is a section of which the mechanical performance is to be evaluated, the initial subgrade reaction modulus is used to indicate a ratio of a vertical pressure to a deflection s at a target point on a top surface of the subgrade, the initial subgrade reaction modulus is determined on condition that a roadbed of the target road section is under an un-reinforced working condition, and the target road section comprises the roadbed and the subgrade from surface to interior in turn;

wherein the acquisition unit is further configured to acquire a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;

a calculation unit configured to calculating, by the processing device, a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:

$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$

wherein, A, B, C, E, F, G, I, J are respectively preset constants, Pa is standard atmospheric pressure, D is a diameter of a bearing plate in the field plate-bearing test process;

wherein the calculation unit is further configured to calculate an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:

$$R P = L \times {( \frac{u}{D} )}^{4} + M \times {( \frac{u}{D} )}^{3} + N \times {( \frac{u}{D} )}^{2} + Q \times \frac{u}{D} + T$$

wherein, L, M, N, Q, and T are respective preset constants; and

an output unit configured to output the composite subgrade reaction modulus kᵣ and the equivalent thickness RP, so as to provide data support for an engineering processing of the target road section.

In connection with the second aspect of the present disclosure, in a first possible implementing way of the second aspect of the present disclosure, A=−2.994, B=−0.465, C=0.553, E=0.334, F=3.201, G=0.0945, I=0.314, J=0.891.

In connection with the second aspect of the present disclosure, in a second possible implementing way of the second aspect of the present disclosure, L=−1.328, M=2.857, N=−1.762, Q=0.18, T=0.678.

In connection with the second aspect of the present disclosure, in a third possible implementing way of the second aspect of the present disclosure, the acquisition unit is specifically configured to:

acquire a first subgrade reaction modulus kₛ₁ of the subgrade by the field plate-bearing test process;

acquire a data of a load displacement ps curve of a soil body of the subgrade under the un-reinforced working condition;

calculate an inverted second subgrade reaction modulus kₛ₂ by taking the first subgrade reaction modulus kₛ₁, the data of the load displacement ps curve, the preset load p of the subgrade and the geocell parameters of the preset geocell of the subgrade as third input parameters and performing an inversion process, and take the inverted second subgrade reaction modulus kₛ₂ as the initial subgrade reaction modulus kₛ.

In connection with the second aspect of the present disclosure, in a fourth possible implementing way of the second aspect of the present disclosure, the acquisition unit is specifically configured to acquire the initial subgrade reaction modulus kₛ through the field plate-bearing test process after detecting a geocell reinforcement treatment event.

In connection with the second aspect of the present disclosure, in a fifth possible implementing way of the second aspect of the present disclosure, the outputting unit is specifically configured to: generate a road section data report of the target road section based on the composite subgrade reaction modulus kᵣ and the equivalent thickness RP, wherein the road section data report is marked with the composite subgrade reaction modulus kᵣ and the equivalent thickness RP; and output the road section data report.

In a third aspect of the present disclosure, a processing device is provided. The processing device may include a processor and a memory containing a computer program, the processor is configured to:

acquire an initial subgrade reaction modulus kₛ of a subgrade of a target road section by using a field plate-bearing test process, wherein the target road section is a section of which the mechanical performance is to be evaluated, the initial subgrade reaction modulus is used to indicate a ratio of a vertical pressure to a deflection s at a target point on a top surface of the subgrade, the initial subgrade reaction modulus is determined on condition that a roadbed of the target road section is under an un-reinforced working condition, and the target road section comprises the roadbed and the subgrade from surface to interior in turn;

acquire a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;

calculate a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:

$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$

wherein, A, B, C, E, F, G, I, J are respectively preset constants, Pa is standard atmospheric pressure, D is a diameter of a bearing plate in the field plate-bearing test process;

calculate an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:

$$R P = L \times {( \frac{u}{D} )}^{4} + M \times {( \frac{u}{D} )}^{3} + N \times {( \frac{u}{D} )}^{2} + Q \times \frac{u}{D} + T$$

wherein, L, M, N, Q, and T are respectively preset constants; and

output the composite subgrade reaction modulus kᵣ and the equivalent thickness RP, so as to provide data support for an engineering processing of the target road section.

In a fourth aspect of the present disclosure, a computer readable storage medium is provided. Multiple instructions are stored on the computer readable storage medium, the instructions are adapted to be loaded by the processor to perform a method for determining mechanical performance of a road is provided. The method may include:

acquiring, by a processing device, an initial subgrade reaction modulus kₛ of a subgrade of a target road section by using a field plate-bearing test process, wherein the target road section is a section of which the mechanical performance is to be evaluated, the initial subgrade reaction modulus is used to indicate a ratio of a vertical pressure to a deflection s at a target point on a top surface of the subgrade, the initial subgrade reaction modulus is determined on condition that a roadbed of the target road section is under an un-reinforced working condition, and the target road section comprises the roadbed and the subgrade from surface to interior in turn;

acquiring, by the processing device, a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;

calculating, by the processing device, a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:

$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$

wherein, A, B, C, E, F, G, I, J are respectively preset constants, Pa is standard atmospheric pressure, D is a diameter of a bearing plate in the field plate-bearing test process;

calculating, by the processing device, an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:

$$R P = L \times {( \frac{u}{D} )}^{4} + M \times {( \frac{u}{D} )}^{3} + N \times {( \frac{u}{D} )}^{2} + Q \times \frac{u}{D} + T$$

wherein, L, M, N, Q, and T are respectively preset constants; and

outputting, by the processing device, the composite subgrade reaction modulus kᵣ and the equivalent thickness RP, so as to provide data support for an engineering processing of the target road section.

As can be known from the above content, the present disclosure has the following advantageous effects.

For the geocell reinforcement scenario of the road, the present disclosure first obtains an initial subgrade reaction modulus kₛ of a subgrade of a target road section whose mechanical performance is to be evaluated by using a field plate-bearing test process, wherein the initial subgrade reaction modulus is determined on condition that a roadbed of the target road section is under an un-reinforced working condition; then calculates a composite subgrade reaction modulus kᵣ of the subgrade on condition that the roadbed is under a reinforced working condition by putting the obtained initial subgrade reaction modulus kₛ, the preset load p of the subgrade, and geocell parameters of the preset geocell of the subgrade into a composite modulus calculation formula, so as to provide data support of the subgrade reaction modulus under the reinforced working condition; on the other hand, the processing device also calculates an equivalent thickness RP of the roadbed under the reinforced working condition in combination with a depth adjustment calculation formula, so as to provide data support of the equivalent thickness of the roadbed under the reinforced working condition. In practical operation, the two data supports can provide accurate and effective data support for facilitating the progress of a geocell reinforcement work in a case of introducing the geocell to reinforce the roadbed.

### BRIEF DESCRIPTION OF THE DRAWINGS

In order to more clearly explain the technical solutions in the embodiments of the present disclosure, the drawings to be used in the description of embodiments will be briefly introduced below. It is obvious that, the drawings described in the following simply involve some embodiments of the present disclosure. For those skilled in the art, other drawings can be obtained based on these drawings without paying creative labor.

FIG. 1 is a flow chart of a method for determining mechanical performance of a road according to the present disclosure;

FIG. 2 is a structural diagram of a road section according to the present disclosure;

FIG. 3 is a scenario diagram of a subgrade according to the present disclosure;

FIG. 4 is a schematic diagram of a data of a load displacement ps curve according to the present disclosure;

FIG. 5 is a flow chart of an inversion processing according to the present disclosure;

FIG. 6 shows a structural diagram of an apparatus for determining mechanical performance of a road according to the present disclosure; and

FIG. 7 is a structural diagram of a processing device according to the present disclosure.

### DETAILED DESCRIPTION

The technical solutions in the embodiments of the present disclosure will be clearly and completely described below in combination with the drawings in the embodiments of the present disclosure. It is obvious that, the embodiments described are only some of embodiments of the present disclosure rather than all embodiments. All other embodiments obtained by those skilled in the art based on the embodiments in the present disclosure without paying creative labor belong to the scope of the present disclosure.

The terms “first”, “second” and the like in the specification, claims and the drawings are used to distinguish similar objects, instead of describing specific sequences or order. It should be understood that the number used in this way can be exchanged under appropriate circumstances so that the embodiments described here can be implemented in an order except that in the content described or illustrated herein. In addition, the terms, “comprising”, “including” and “having” as well as any of their varieties are intended to have a non-exclusive meaning. For example, any process, method, system, product, or apparatus comprising a series of steps or modules is not necessarily limited to those steps or modules expressly listed; instead, it can include other steps or modules that are not expressly listed or inherent to the process, method, product, or apparatus. The naming or numbering of the steps appearing in the present disclosure does not mean that the steps in the method or process must be performed in the order of the time/logic indicated by the naming or numbering; instead, the steps or procedures being named or numbered can be performed in an altered order according to the technical purpose to be realized, as long as the same or similar technical effects can be achieved.

The division of the modules appearing in the present disclosure is a logical division. There can be other way to divide the modules in actual application. For example, multiple modules can be combined or integrated in another system, or some features can be ignored or not executed; in addition, the coupling or direct coupling or communication connection between modules that are illustrated or discussed can be performed through some interfaces, and the indirect coupling or communication connection between modules can be electrical or other similar forms, which are not limited in the present disclosure. Further, the modules or sub-modules described as separate components may be or may not be physically separated, may be or may not be physical modules, or they can be distributed in multiple circuit modules. They can be selected in part or in whole according to actual needs to achieve the purpose of the solutions of the present disclosure.

In face of the problems such as poor compactness of subgrade fillers during construction process or roadbed deterioration possibly occurred during a service life, it will be a feasible and effective way to adjust and control the structural performance of the roadbed of a road in order to increase the entire rigidity of the whole roadbed and even the whole subgrade during the construction process.

In the process of current researching in some implementations, the inventors found that the existing schemes for adjusting and controlling the structural performance of the roadbed of the road typically achieve reinforcements by way of filling replacement, in-situ treatment, or the like. However, the filling replacement above all brings about large construction cost, and the in-situ treatment, for example lime addition, not only affects environment, but also needs a certain period of time for maintenance. Thus, the existing processing for adjusting and controlling the structural performance of the roadbed of the road have a problem of high application cost.

Before introducing the method for determining mechanical performance of a road provided by the present disclosure, firstly the background of the present disclosure will be introduced.

The method, apparatus or computer readable storage medium for determining mechanical performance of a road provided in the present disclosure can be applied to a processing device, so as to provide accurate and effective data support for facilitating the progress of the geocell reinforcement work in a case of introducing geocell to reinforce the roadbed of the road.

As to the method for determining mechanical performance of the road mentioned in the present disclosure, its executor can be an apparatus, or a processing device of various types which is integrated with an apparatus for determining mechanical performance of a road, such as a server, a physical host or a user equipment (UE). The apparatus for determining mechanical performance of the road can be implemented by hardware or software. The UE can specifically be terminal devices such as smartphones, tablets, laptops, desktop computers, or personal digital assists (PDA). The processing device can be embodied as a device cluster.

The method for determining mechanical performance of a road provided by the present disclosure will be introduced in the following.

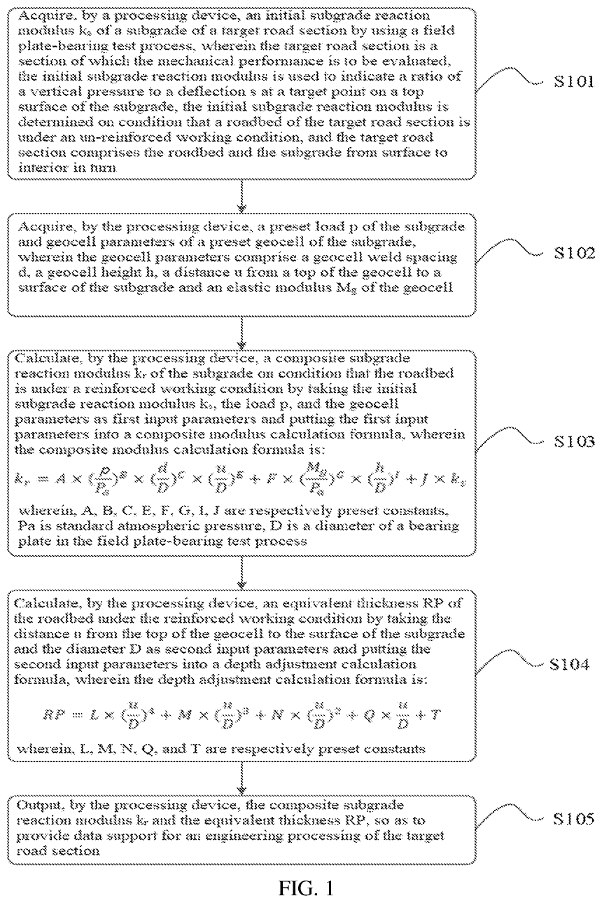

Firstly, referring to FIG. 1, which shows a flow chart of a method for determining mechanical performance of a road according to the present disclosure, the method may comprise the following steps S101-S105.

In step S101, an initial subgrade reaction modulus kₛ of a subgrade of a target road section is obtained by a processing device using a field plate-bearing test process, wherein the target road section is a section of which the mechanical performance is to be evaluated, and the initial subgrade reaction modulus is used to indicate a ratio of a vertical pressure to a deflection s at a target point on a top surface of the subgrade; the initial subgrade reaction modulus is determined on condition that a roadbed of the target road section is under an un-reinforced working condition, and the target road section includes the roadbed and the subgrade from surface to interior in turn.

It can be understood that the subgrade reaction modulus is a data indicator commonly used in the geological field, in particular in the road construction and the maintenance work. The present disclosure considers influences on the performance after adding a geocell in the roadbed based on the subgrade reaction modulus and re-predicts the subgrade reaction modulus, and then predicts new mechanical performance after adding the geocell in the roadbed, so that it can provide accurate and effective data support for the construction and maintenance of the road. In particular, it can realize evaluation in advance, i.e., before the geocell is putted into use and laid into the roadbed, so as to choose reasonable geocell reinforcement solution and thus facilitate the progress of the project.

The subgrade reaction modulus indicates a ratio of a vertical pressure to a deflection s at a target point on the top surface of the subgrade and can reflect the loading capacity of the subgrade.

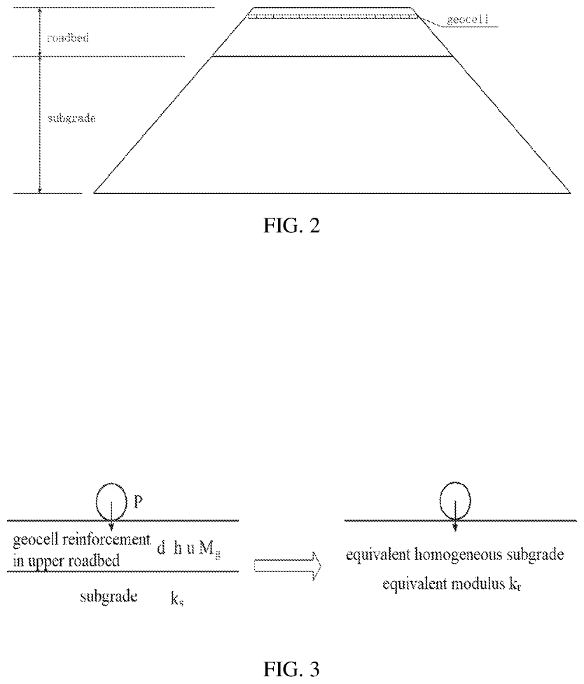

Further, in the present disclosure, referring to a structural schematic diagram of a road section of the present disclosure shown in FIG. 2, the roadbed can be strengthened by laying a geocell. The geocell can be understood as a three-dimensional mesh structure formed by reinforced HDPE sheet material after being high strength welded, which can achieve reinforcement effect and improve the intensity of the subgrade. It has advantages of being economical and practical, being convenient in laying, and having good reinforcement effect. The laying of the geocell can speed up the construction period and reduce the construction cost compared with other construction method.

Under this circumstance, a state before the geocell is laid into the roadbed can be called an un-reinforced working condition; correspondingly, a state after the geocell is laid into the roadbed can be called a reinforced working condition.

In the present disclosure, the initial subgrade reaction modulus kₛ can be determined using a plate-bearing test process. The bearing plate test processing is widely used in rock and soil engineering and subgrade engineering industries, and applies pressure on a sample of the road section based on a circular bearing plate to simulate different use conditions of the road, and loads on the surface of the soil matrix through the bearing plate step by step (the load is generally represented by p) to observe different deformations in response to different loads, so as to measure the vertical pressure and the defection s at the target point on the top surface of each of respective subgrades in different groups.

As to obtaining the initial subgrade reaction modulus kₛ through the bearing plate test process, it can be interpreted as directly extracting the initial subgrade reaction modulus kₛ from data related to the bearing plate test processing, or extracting initial data from data related to the bearing plate test processing to determine the initial subgrade reaction modulus kₛ; alternatively, it can be interpreted as triggering and initiating the bearing plate test processing to obtain the initial subgrade reaction modulus kₛ.

Now, it can be seen that the subgrade reaction modulus involved in the present disclosure comprises subgrade reaction moduli corresponding to different points, and has multiple groups of data.

In some embodiments, corresponding to the progress of actual project work, the processing device can also detect whether there is a geocell laying work on the target road section based on a database or a system. If a geocell reinforcement event is detected, the initial subgrade reaction modulus kₛ may be obtained after the geocell reinforcement event is detected.

It can be understood that this arrangement realizes a processing mechanism to automatically update the data of the geocell reinforcement work in response to initiating the geocell reinforcement work, which is conducive to improving use efficiency and convenience of the present disclosure in actual operation.

In step S102, a preset load p of the subgrade and geocell parameters of a preset geocell of the subgrade are acquired by the processing device, and the geocell parameters includes a geocell weld spacing d, a geocell height h, a distance u from the top of the geocell to the surface of the subgrade and an elastic modulus M_{g} of the geocell.

When the subgrade reaction modulus under the reinforced working condition is calculated based on the initial subgrade reaction modulus kₛ under the un-reinforced working condition, the present disclosure can perform data processing according to the input parameters involved in the computing formula provided herein, so as to obtain the preset load p of the subgrade and the geocell parameters of the preset geocell of the subgrade in relation to the input parameters.

It can be understood that the preset load p can be interpreted as an expected load involved in a design goal or maintenance goal of the target road section, and the preset geocell can be interpreted as a specific geocell selected by a geocell laying project, which can generally be identified by a geocell model.

It can be seen that the preset load p and the preset geocell are generally determined by a working staff member. At present, in some special cases, it may also be automatically screened and determined by a machine. In the present disclosure, both of the preset load p and the preset geocell are generally obtained by a data capture, such as captured from the local processing device, or from other processing device, or from a database of the current road construction and maintenance project.

For different models of geocell, parameters such as the geocell weld spacing d, the geocell height h, the distance u from the top of the geocell to the surface of the subgrade and elastic modulus M_{g} of the geocell can all be set in advance.

In step S103, a composite subgrade reaction modulus kᵣ of the subgrade on condition that the roadbed is under a reinforced working condition is calculated by the processing device taking the initial subgrade reaction modulus kₛ, the load p, and the geocell parameters as input parameters and putting them into a composite modulus calculation formula, and the composite modulus calculation formula is:

$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$

wherein, A, B, C, E, F, G, I, J are respectively preset constants; Pa is the standard atmospheric pressure; D is a diameter of the bearing plate in the field plate-bearing test process.

It can be understood that referring to a scenario diagram of the subgrade shown in FIG. 3, the present disclosure provides a specific determination strategy for the subgrade reaction modulus under the reinforced working condition, i.e., the above composite modulus calculation formula. By the calculation processing of the formula, the subgrade reaction modulus under the reinforced working condition, i.e., the composite reaction modulus, can be calculated with the involved input parameters including the initial subgrade reaction modulus kₛ, the load p, and the geocell parameters (including the weld spacing d, the geocell height h, the distance u from the top of the geocell to the surface of the subgrade, the elasticity modulus M_{g} of the geocell, etc.) and other parameters.

The composite reaction modulus can accurately and effectively reflect the load capacity of the subgrade after the geocell is laid into the roadbed and help the decision-making and progress of the engineering project.

The above description has mentioned that in the present disclosure, specifically, the initial subgrade reaction modulus kₛ under the un-reinforced working condition can be obtained through a field plate-bearing test process. Further, the diameter D of the (circular) bearing plate involved in the field plate-bearing test process is also one of input parameters for the composite modulus calculation formula.

The present disclosure considers that different input parameters can have different contributions to the subgrade reaction modulus. Therefore, constant coefficients can be set to adjust the contribution of each item in the composite modulus calculation formula.

As a specific implementation way, the present disclosure starts from actual project experience and combines a large number of fitting tests to set these constant coefficients as: A=−2.994, B=−0.465, C=0.553, E=0.334, F=3.201, G=0.0945, I=0.314, J=0.891.

In step S104, an equivalent thickness RP of the roadbed under the reinforced working condition is calculated by the processing device taking the distance u from the top of the geocell to the surface of the subgrade and the diameter D as second input parameters and putting the second input parameters into a depth adjustment calculation formula, and the depth adjustment calculation formula is shown as follows:

$$R P = L \times {( \frac{u}{D} )}^{4} + M \times {( \frac{u}{D} )}^{3} + N \times {( \frac{u}{D} )}^{2} + Q \times \frac{u}{D} + T$$

wherein, L, M, N, Q, and T are respectively preset constants.

It can be understood that for a geocell reinforcement scenario of the road, on the one hand, the present disclosure can predict data support of subgrade reaction modulus after reinforcing through the geocell; and on the other hand, the present disclosure can also provide the predicted equivalent thickness of the roadbed after reinforcing through the geocell and provide accurate and effective data support for mechanical performance such as effective thickness of the reinforced roadbed, and the like.

It can be understood that for effective thickness of the reinforced roadbed after reinforcement, the present disclosure also provides a depth adjustment calculation formula. The present disclosure considers that after laying the geocell, the laid depth u of the geocell is a main influence factor for determining the effective thickness of the roadbed. Thus, a calculation formula for u is also provided so as to determine the effective thickness of the roadbed after reinforcement.

The present disclosure considers that different input parameters can have different contributions to the equivalent thickness. Therefore, constant coefficients can be set to adjust the contribution of each item in the composite modulus calculation formula.

As a specific implementation way, the present disclosure starts from actual project experiences and combines a large number of fitting tests to set these constant coefficients as: L=−1.328, M=2.857, N=−1.762, Q=0.18, T=0.678.

In step S105, the composite subgrade reaction modulus kᵣ and the equivalent thickness RP are outputted by the processing device, so as to provide data support for an engineering processing of the target road section.

After obtaining the two kinds of data of subgrade reaction modulus and equivalent thickness by the above data processing, the processing device can output the corresponding data according to pre-configured output strategy to provide accurate and effective data support for the relevant engineering processing of the road section.

It can be understood that the output way involved herein is specifically adjustable with the output strategy, for example, it can be simple data presentation and data transmission.

Further, the output strategy may also involve data processing.

It can be understood that in the engineering processing, it may also involve the display of data report of road section. The data report of road section can be interpreted as an engineering report, or a report involved in the construction and maintenance projects of the target road section, which are used to reflect relevant data of the target road section.

In this situation, as another implementation way suitable for use, the composite subgrade reaction modulus kᵣ and the equivalent thickness RP can be output through this type of data report for the road section.

That is, the processing device can generate a road section data report regarding the target road section on the basis of the composite subgrade reaction modulus kᵣ and the equivalent thickness RP in combination with other necessary data from the data report of road section. The road section data report is marked with the composite subgrade reaction modulus kᵣ and the equivalent thickness RP, and then is outputted. Under this arrangement, an implementation solution which better meets practical needs and engineering work can be provided for the output of the composite subgrade reaction modulus and the equivalent thickness RP.

From the embodiment shown in FIG. 1, it can be seen that for the geocell reinforcement scenario of the road, the present disclosure first obtains an initial subgrade reaction modulus kₛ of a subgrade of a target road section whose mechanical performance is to be evaluated by using a field plate-bearing test process, wherein the initial subgrade reaction modulus is determined on condition that a roadbed of the target road section is under an un-reinforced working condition; then calculates a composite subgrade reaction modulus kᵣ of the subgrade on condition that the roadbed is under a reinforced working condition by putting the obtained initial subgrade reaction modulus kₛ, the preset load p of the subgrade, and geocell parameters of the preset geocell of the subgrade into a composite modulus calculation formula, so as to provide data support of the subgrade reaction modulus under the reinforced working condition. On the other hand, the processing device also calculates an equivalent thickness RP of the roadbed under the reinforced working condition in combination with a depth adjustment calculation formula, so as to provide data support of the equivalent thickness of the roadbed under the reinforced working condition. In practical operation, the two data supports can provide accurate and effective data support for facilitating the progress of a geocell reinforcement work in a case of introducing the geocell to reinforce the roadbed.

Further, the present disclosure also provides another method for determining the subgrade reaction modulus. The determination method is performed by further introducing an inversion process on the basis of the field plate-bearing test process, which specifically comprises:

acquiring, by the processing device, a first subgrade reaction modulus kₛ₁ of the subgrade by the field plate-bearing test process;

acquiring, by the processing device, a data of a load displacement ps curve of a soil body of the subgrade on condition that the roadbed is under an un-reinforced working condition; and

calculating, by the processing device, an inverted second subgrade reaction modulus kₛ₂ by taking the first subgrade reaction modulus kₛ₁, the data of the load displacement ps data, the preset load p of the subgrade and the geocell parameters of the preset geocell of the subgrade as third input parameters and performing an inversion process, and taking, by the processing device, the inverted second subgrade reaction modulus kₛ₂ as the initial subgrade reaction modulus kₛ.

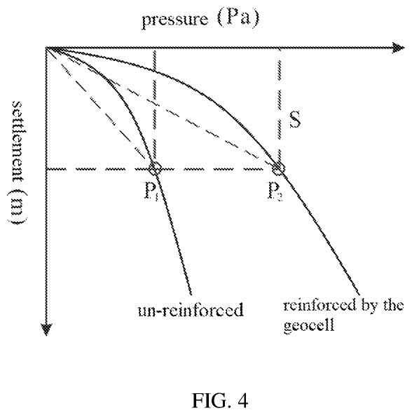

Referring to FIG. 4 which shows a schematic diagram of the data of the load displacement ps curve according to the present disclosure, in the load displacement ps curve, under the action of a load p2, the deflection of the roadbed after reinforcement (laying the geocell) is s; at this time, it can be known from the value of the un-reinforced ps curve that, when the deflection is s, the subgrade reaction modulus provided by the soil body is P1/s, i.e., kₛ in step S101.

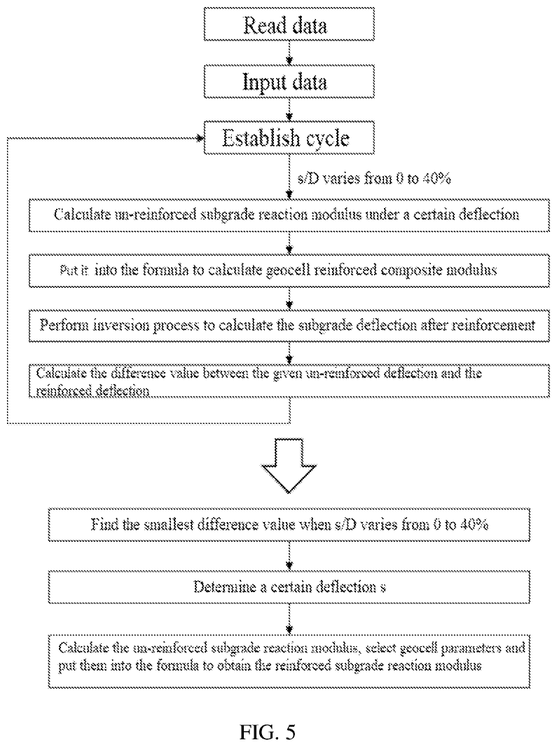

The present disclosure further considers that in the actual calculation, after the load p is given, it is impossible to accurately learn the contribution of the reinforced soil body to the composite modulus, that is, the kₛ cannot be accurately obtained. Thus, the present disclosure also provides an inversion concept, which can use common programming language or Excel, or the like to compile calculation formulas, so as to perform the inversion calculation according to a flow chart of inversion process of the present disclosure shown in FIG. 5 to obtain kₛ.

Taking an actual situation as an example, in a certain project, parameters of the selected geocell are:

M_{g}=235 MPa,

d/D=1.18,

h/D=0.5,

u/D=0.0667,

the preset load p is 300 kPa.

Before calculation, the ps curve of un-reinforced soil body has been obtained. By the inversion process, the subgrade reaction modulus under un-reinforced working condition is calculated to be 13.95 MN/m³. The above parameters are put into steps S102-S103 again for calculation and the composite subgrade reaction modulus kᵣ about 17 MN/m³ after reinforcement is obtained.

It can be understood that the inversion process is conducted based on a simulation and backward deduction way. According to the ps curve, multiple kₛ values under different deformations are obtained for trial calculation; and finally, the most reasonable kₛ is screened based on the principle of equal displacement.

It can be understood that kₛ obtained under this arrangement is acquired based on actual test processing and has authenticity of data; furthermore, because the inversion process is further introduced to deeply and finely analyze the subgrade reaction modulus from the perspective of data processing, thus, higher data accuracy can be obtained.

The above is the introduction of the method for determining mechanical performance of the road provided by the present disclosure. In order to better implement the method for determining mechanical performance of the road provided by the present disclosure, the present disclosure also provides an apparatus for determining mechanical performance of a road from the perspective of functional modules.

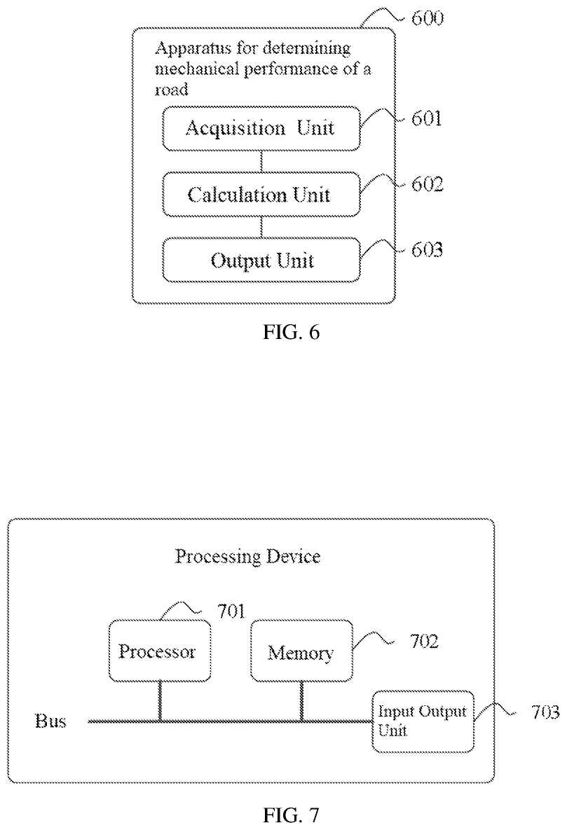

Referring to FIG. 6, which is a structural diagram of the apparatus for determining mechanical performance of a road according to the present disclosure. In the present disclosure, the apparatus 600 for determining mechanical performance of a road can specifically include an acquisition unit 601, a calculation unit 602, and an output unit 603.

The acquisition unit 601 is configured to acquire an initial subgrade reaction modulus kₛ of a subgrade of a target road section by using a field plate-bearing test process, wherein the target road section is a section of which the mechanical performance is to be evaluated, the initial subgrade reaction modulus is used to indicate a ratio of a vertical pressure to a deflection s at a target point on a top surface of the subgrade, the initial subgrade reaction modulus is determined on condition that a roadbed of the target road section is under an un-reinforced working condition, and the target road section comprises the roadbed and the subgrade from surface to interior in turn.

The acquisition unit 601 is further configured to acquire, a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell.

The calculation unit 602 is configured to calculate a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:

$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$

wherein, A, B, C, E, F, G, I, J are respectively preset constants, Pa is standard atmospheric pressure, D is a diameter of a bearing plate in the field plate-bearing test process.

The calculation unit 602 is further configured to calculate an equivalent thickness RP of the roadbed under the reinforced working condition by taking the distance u from the top of the geocell to the surface of the subgrade and the diameter D as second input parameters and putting the second input parameters into a depth adjustment calculation formula, and the depth adjustment calculation formula is:

$$R P = L \times {( \frac{u}{D} )}^{4} + M \times {( \frac{u}{D} )}^{3} + N \times {( \frac{u}{D} )}^{2} + Q \times \frac{u}{D} + T$$

wherein, L, M, N, Q, and T are respectively preset constants.

The output unit 603 is configured to output the composite subgrade reaction modulus kᵣ and the equivalent thickness RP, so as to provide data support for an engineering processing of the target road section.

In an exemplary implementation, A=−2.994, B=−0.465, C=0.553, E=0.334, F=3.201, G=0.0945, I=0.314, J=0.891.

In another exemplary implementation way, L=−1.328, M=2.857, N=−1.762, Q=0.18, T=0.678.

In another exemplary implementation way, the acquisition unit 601 is specifically configured to:

acquire a first subgrade reaction modulus kₛ₁ of the subgrade by the field plate-bearing test process;

acquire a data of a load displacement ps curve of a soil body of the subgrade under the un-reinforced working condition; and

calculate an inverted second subgrade reaction modulus kₛ₂ by taking the first subgrade reaction modulus kₛ₁, the data of the load displacement ps curve, the preset load p of the subgrade and the geocell parameters of the preset geocell of the subgrade as third input parameters and performing an inversion process, and take the inverted second subgrade reaction modulus kₛ₂ as the initial subgrade reaction modulus kₛ.

In another exemplary implementation way, the acquisition unit 601 is specifically configured to acquire the initial subgrade reaction modulus kₛ through the field plate-bearing test process after detecting a geocell reinforcement treatment event.

In another exemplary implementation way, the output unit 603 is specifically configured to:

generate a road section data report of the target road section based on the composite subgrade reaction modulus kᵣ and the equivalent thickness RP, wherein the road section data report is marked with the composite subgrade reaction modulus kᵣ and the equivalent thickness RP; and

output the road section data report.

The present disclosure also provides a processing device from the perspective of hardware structure. Referring to FIG. 7, showing a structural diagram of the processing device of the present disclosure, specifically, the processing device of the present disclosure may include a processor 701, a memory 702, and an input and output unit 703. The processor 701 is used to perform the respective steps of the method for determining mechanical performance of the road according the embodiment corresponding to FIG. 1 upon executing the computer program stored in the memory 701; or, the processor 701 is used to achieve the functions of the respective units in the embodiment corresponding to FIG. 6 upon executing the computer program stored in the memory 702. The memory 702 is configured for storing the computer program required for the processor 701 to perform the method for determining mechanical performance of the road in the embodiment corresponding to FIG. 1.

For example, the computer program can be divided into one or more modules/units, the one or more modules/units can be stored in the memory 702, and executed by the processor 701 to realize the present disclosure. the one or more modules/units can be a series of computer program instruction segments that can accomplish specific functions. The instruction segments are used to describe execution process of the computer program in the computer device.

The processing device may include, but not limited to a processor 701, a memory 702, and an input and output unit 703. The technical personnel in the art can understand that it is just an example of the processing device, and does not constitute a limitation on the processing device. It can include more or less components than illustrated in the drawings, or combine some components, or different components. For example, the processing device can also include network access device, bus, etc. The processor 701, the memory 702 and the input and output unit 703, etc. are connected through the bus.

The processor 701 can be a central processing unit (CPU), or other general processors, such as a digital signal processor (DSP), an application specific integrated subgrade (ASIC), a field programmable gate array (FPGA) or other programmable logic devices, discrete gate or transistor logic devices, discrete hardware components, etc. The general processor may be a microprocessor or the processor may be any conventional processor. The processor is the control center of the processing device and connects respective parts of the whole device by using of various interfaces and lines.

The memory 702 can be used to store computer programs and/or modules. The processor 701 achieves various functions of the computer device by running or executing the computer programs and/or modules stored in the memory 702 and calling the data stored in the memory 702. The memory 702 may mainly include a program storage area and a data storage area, wherein the program storage area can store an operating system, applications required by at least one function, etc.; the data storage area can store the data created according to the use of the processing device. In addition, the memory can include a high-speed random access memory, as well as nonvolatile memory, such as hard disks, an internal memory, plug-in hard disks, smart memory cards (SMC), Security Digital (SD) card, Flash Card, at least one disk storage device, flash memory device, or other volatile solid storage devices.

When the processor 701 is used to perform computer program stored in the memory 702, the following functions can be implemented:

acquire an initial subgrade reaction modulus kₛ of a subgrade of a target road section by using a field plate-bearing test process, wherein the target road section is a section of which the mechanical performance is to be evaluated, the initial subgrade reaction modulus is used to indicate a ratio of a vertical pressure to a deflection s at a target point on a top surface of the subgrade, the initial subgrade reaction modulus is determined on condition that a roadbed of the target road section is under an un-reinforced working condition, and the target road section comprises the roadbed and the subgrade from surface to interior in turn;

acquire a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;

calculate a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:

$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$

wherein, A, B, C, E, F, G, I, J are respectively preset constants, Pa is standard atmospheric pressure, D is a diameter of a bearing plate in the field plate-bearing test process;

calculate an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:

$$R P = L \times {( \frac{u}{D} )}^{4} + M \times {( \frac{u}{D} )}^{3} + N \times {( \frac{u}{D} )}^{2} + Q \times \frac{u}{D} + T$$

wherein, L, M, N, Q, and T are respectively preset constants;

output the composite subgrade reaction modulus kᵣ and the equivalent thickness RP, so as to provide data support for an engineering processing of the target road section.

Those skilled in the art may clearly understand that for the convenience and simplicity in description, the specific working process of the apparatus, the processing device and their corresponding units for determining mechanical performance of a road as described above can be known by referring to the explanation of the method for determining the mechanical performance of a road in the embodiments corresponding to FIG. 1, which will not be repeated here.

Those of ordinary skill in the art can understand that all or part of the steps in the various methods of the above embodiments can be completed by instructions, or by instructions that control relevant hardware, and the instructions can be stored in a computer-readable storage medium, and loaded and executed by the processor.

To this end, the present disclosure provides a computer-readable storage medium, in which a plurality of instructions is stored, and the instructions can be loaded by a processor to execute the steps of the method for determining the mechanical performance of a road in the embodiment corresponding to FIG. 1 of the present disclosure. For specific operations, reference may be made to the description of the method for determining the mechanical performance of a road in the embodiment corresponding to FIG. 1, which will not be repeated here.

The computer readable storage medium may include: Read Only Memory (ROM), Random Access Memory (RAM), a magnetic disk or an optical disc.

Because the instructions stored in the computer readable storage medium can execute the steps of the method for determining mechanical performance of a road in the embodiment corresponding to FIG. 1 of the present disclosure, it can achieve the beneficial effects that can be achieved by the method for determining mechanical performance of a road in the embodiment corresponding to FIG. 1 of the present disclosure, which can be known by referring to the previous description and will not be repeated here.

The method, apparatus, processing device, and computer readable storage media for determining mechanical performance of a road provided by the present disclosure are fully described in the above. Although in this article, the specific examples are used to explain the principles and implementation methods of the present disclosure, the description of the embodiments is only used to help understand the methods and core ideas of the present disclosure. For those skilled in the art, the specific implementing way and application scope may be modified based on the concept of the present disclosure. Thus, the content of the description should not be interpreted as limiting the present disclosure.

What is claimed is:

1. A method for determining mechanical performance of a road, comprising:
acquiring, by a processing device, an initial subgrade reaction modulus kₛ of a subgrade of a target road section by using a field plate-bearing test process, wherein the target road section is a section of which the mechanical performance is to be evaluated, and the initial subgrade reaction modulus is used to indicate a ratio of a vertical pressure to a deflection s at a target point on a top surface of the subgrade, and the initial subgrade reaction modulus is determined on condition that a roadbed of the target road section is under an un-reinforced working condition, and the target road section comprises the roadbed and the subgrade from surface to interior in turn;
acquiring, by the processing device, a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;
calculating, by the processing device, a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:
$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$
wherein, A, B, C, E, F, G, I, J are respectively preset constants, and Pa is standard atmospheric pressure, and D is a diameter of a bearing plate in the field plate-bearing test process;
calculating, by the processing device, an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:
$$R P = L \times {( \frac{u}{D} )}^{4} + M \times {( \frac{u}{D} )}^{3} + N \times {( \frac{u}{D} )}^{2} + Q \times \frac{u}{D} + T$$
wherein, L, M, N, Q, and T are respectively preset constants; and
outputting, by the processing device, the composite subgrade reaction modulus kᵣ and the equivalent thickness RP, so as to provide data support for an engineering processing of the target road section.

2. The method according to claim 1, wherein A=−2.994, B=−0.465, C=0.553, E=0.334, F=3.201, G=0.0945, I=0.314, J=0.891.

3. The method according to claim 1, wherein L=−1.328, M=2.857, N=−1.762, Q=0.18, T=0.678.

4. The method according to claim 1, wherein the acquiring, by the processing device, the initial subgrade reaction modulus kₛ of the subgrade of the target road section using the field plate-bearing test process comprises:
acquiring, by the processing device, a first subgrade reaction modulus kₛ₁ of the subgrade by the field plate-bearing test process;
acquiring, by the processing device, a data of a load displacement ps curve of a soil body of the subgrade under the un-reinforced working condition; and
calculating, by the processing device, an inverted second subgrade reaction modulus kₛ₂ by taking the first subgrade reaction modulus kₛ₁, the data of the load displacement ps curve, the preset load p of the subgrade and the geocell parameters of the preset geocell of the subgrade as third input parameters and performing an inversion process, and taking, by the processing device, the inverted second subgrade reaction modulus kₛ₂ as the initial subgrade reaction modulus kₛ.

5. The method according to claim 1, wherein the acquiring, by the processing device, the initial subgrade reaction modulus kₛ of the subgrade of the target road section using the field plate-bearing test process comprises:
after detecting a geocell reinforcement treatment event, acquiring, by the processing device, the initial subgrade reaction modulus kₛ through the field plate-bearing test process.

6. The method according to claim 1, wherein the outputting, by the processing device, the composite subgrade reaction modulus kᵣ and the equivalent thickness RP comprises:
generating, by the processing device, a road section data report of the target road section based on the composite subgrade reaction modulus kᵣ and the equivalent thickness RP, wherein the road section data report is marked with the composite subgrade reaction modulus kᵣ and the equivalent thickness RP; and
outputting, by the processing device, the road section data report.

7. A processing device, comprising a processor and a memory stored with a computer program, wherein the processer is configured to:
acquire an initial subgrade reaction modulus kₛ of a subgrade of a target road section by using a field plate-bearing test process, wherein the target road section is a section of which the mechanical performance is to be evaluated, and the initial subgrade reaction modulus is used to indicate a ratio of a vertical pressure to a deflection s at a target point on a top surface of the subgrade, and the initial subgrade reaction modulus is determined on condition that a roadbed of the target road section is under an un-reinforced working condition, and the target road section comprises the roadbed and the subgrade from surface to interior in turn;
acquire a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;
calculate a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:
$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$
wherein, A, B, C, E, F, G, I, J are respectively preset constants, and Pa is standard atmospheric pressure, and D is a diameter of a bearing plate in the field plate-bearing test process;
calculate an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:
$$R P = L \times {( \frac{u}{D} )}^{4} + M \times {( \frac{u}{D} )}^{3} + N \times {( \frac{u}{D} )}^{2} + Q \times \frac{u}{D} + T$$
wherein, L, M, N, Q, and T are respectively preset constants; and
output the composite subgrade reaction modulus kᵣ and the equivalent thickness RP, so as to provide data support for an engineering processing of the target road section.

8. The processing device according to claim 7, wherein A=−2.994, B=−0.465, C=0.553, E=0.334, F=3.201, G=0.0945, I=0.314, J=0.891.

9. The processing device according to claim 7, wherein L=−1.328, M=2.857, N=−1.762, Q=0.18, T=0.678.

10. The processing device according to claim 7, wherein the processor is configured to:
acquire a first subgrade reaction modulus kₛ₁ of the subgrade by the field plate-bearing test process;
acquire a data of a load displacement ps curve of a soil body of the subgrade under the un-reinforced working condition; and
calculate an inverted second subgrade reaction modulus kₛ₂ by taking the first subgrade reaction modulus kₛ₁, the data of the load displacement ps curve, the preset load p of the subgrade and the geocell parameters of the preset geocell of the subgrade as third input parameters and performing an inversion process, and taking, by the processing device, the inverted second subgrade reaction modulus kₛ₂ as the initial subgrade reaction modulus kₛ.

11. The processing device according to claim 7, wherein the processor is configured to:
after detecting a geocell reinforcement treatment event, acquire the initial subgrade reaction modulus kₛ through the field plate-bearing test process.

12. The processing device according to claim 7, wherein the processor is configured to:
generate a road section data report of the target road section based on the composite subgrade reaction modulus kᵣ and the equivalent thickness RP, wherein the road section data report is marked with the composite subgrade reaction modulus kᵣ and the equivalent thickness RP; and
output the road section data report.

13. A computer readable storage medium on which multiple instructions are stored, wherein the instructions are adapted to be loaded by the processor to perform a method for determining mechanical performance of a road,
wherein the method for determining mechanical performance of the road comprises:
acquiring, by a processing device, an initial subgrade reaction modulus kₛ of a subgrade of a target road section by using a field plate-bearing test process, wherein the target road section is a section of which the mechanical performance is to be evaluated, and the initial subgrade reaction modulus is used to indicate a ratio of a vertical pressure to a deflection s at a target point on a top surface of the subgrade, and the initial subgrade reaction modulus is determined on condition that a roadbed of the target road section is under an un-reinforced working condition, and the target road section comprises the roadbed and the subgrade from surface to interior in turn;
acquiring, by the processing device, a preset load p of the subgrade and geocell parameters of a preset geocell of the subgrade, wherein the geocell parameters comprise a geocell weld spacing d, a geocell height h, a distance u from a top of the geocell to a surface of the subgrade and an elastic modulus M_{g} of the geocell;
calculating, by the processing device, a composite subgrade reaction modulus kᵣ of the subgrade on condition that the roadbed is under a reinforced working condition by taking the initial subgrade reaction modulus kₛ, the load p, and the geocell parameters as first input parameters and putting the first input parameters into a composite modulus calculation formula, wherein the composite modulus calculation formula is:
$${k}_{r} = A \times {( \frac{p}{{P}_{a}} )}^{B} \times {( \frac{d}{D} )}^{C} \times {( \frac{u}{D} )}^{E} + F \times {( \frac{{M}_{g}}{{P}_{a}} )}^{G} \times {( \frac{h}{D} )}^{I} + J \times {k}_{s}$$
wherein, A, B, C, E, F, G, I, J are respectively preset constants, and Pa is standard atmospheric pressure, and D is a diameter of a bearing plate in the field plate-bearing test process;
calculating, by the processing device, an equivalent thickness RP of the roadbed under the reinforced working condition by taking the distance u from the top of the geocell to the surface of the subgrade and the diameter D as second input parameters and putting the second input parameters into a depth adjustment calculation formula, wherein the depth adjustment calculation formula is:
$$R P = L \times {( \frac{u}{D} )}^{4} + M \times {( \frac{u}{D} )}^{3} + N \times {( \frac{u}{D} )}^{2} + Q \times \frac{u}{D} + T$$
wherein, L, M, N, Q, and T are respectively preset constants; and
outputting, by the processing device, the composite subgrade reaction modulus kᵣ and the equivalent thickness RP, so as to provide data support for an engineering processing of the target road section.

14. The computer readable storage medium according to claim 13, wherein A=−2.994, B=−0.465, C=0.553, E=0.334, F=3.201, G=0.0945, I=0.314, J=0.891.

15. The computer readable storage medium according to claim 13, wherein L=−1.328, M=2.857, N=−1.762, Q=0.18, T=0.678.

16. The computer readable storage medium according to claim 13, wherein the acquiring, by the processing device, the initial subgrade reaction modulus kₛ of the subgrade of the target road section using the field plate-bearing test process comprises:
acquiring, by the processing device, a first subgrade reaction modulus kₛ₁ of the subgrade by the field plate-bearing test process;
acquiring, by the processing device, a data of a load displacement ps curve of a soil body of the subgrade under the un-reinforced working condition; and
calculating, by the processing device, an inverted second subgrade reaction modulus kₛ₂ by taking the first subgrade reaction modulus kₛ₁, the data of the load displacement ps curve, the preset load p of the subgrade and the geocell parameters of the preset geocell of the subgrade as third input parameters and performing an inversion process, and taking, by the processing device, the inverted second subgrade reaction modulus kₛ₂ as the initial subgrade reaction modulus kₛ.

17. The computer readable storage medium according to claim 13, wherein the acquiring, by the processing device, the initial subgrade reaction modulus kₛ of the subgrade of the target road section using the field plate-bearing test process comprises:
after detecting a geocell reinforcement treatment event, acquiring, by the processing device, the initial subgrade reaction modulus kₛ through the field plate-bearing test process.

18. The computer readable storage medium according to claim 13, wherein the outputting, by the processing device, the composite subgrade reaction modulus kᵣ and the equivalent thickness RP comprises:
generating, by the processing device, a road section data report of the target road section based on the composite subgrade reaction modulus kᵣ and the equivalent thickness RP, wherein the road section data report is marked with the composite subgrade reaction modulus kᵣ and the equivalent thickness RP; and
outputting, by the processing device, the road section data report.
